(19) United States
(12) Patent Application Publication
(10) Pub. No.: US 2020/0403273 A1
(43) Pub. Date: Dec. 24, 2020

(54) ELECTROLYTES FOR RECHARGEABLE METAL-SULFUR BATTERIES

(71) Applicant: Battelle Memorial Institute, Richland, WA (US)

(72) Inventors: Jiguang Zhang, Richland, WA (US); Xia Cao, Richland, WA (US); Wu Xu, Richland, WA (US)

(73) Assignee: Battelle Memorial Institute, Richland, WA (US)

(21) Appl. No.: 16/904,376

(22) Filed: Jun. 17, 2020

Related U.S. Application Data
(60) Provisional application No. 62/864,092, filed on Jun. 20, 2019.

(51) Int. Cl. H01M 10/0569; H01M 4/38; H01M 10/052; H01M 10/0568; H01M 10/0567

(52) U.S. Cl. CPC H01M 10/0569; H01M 4/382; H01M 2004/027; H01M 10/0568; H01M 10/0567; H01M 10/052

(57) ABSTRACT

One embodiment disclosed herein is an electrolyte composition comprising:
an active salt; and
a solvent portion that comprises at least 10 vol. % of at least one orthoformate or a mixture of orthoformates, based on the total volume of the solvent portion.

### CROSS REFERENCE TO RELATED APPLICATION

This application claims the benefit of U.S. Provisional Patent Application No.

62/864,092, filed Jun. 20, 2019, which is incorporated herein by reference.

### ACKNOWLEDGMENT OF GOVERNMENT SUPPORT

This invention was made with government support under Contract DE-AC0576RL01830 awarded by the U.S. Department of Energy. The government has certain rights in the invention.

### BACKGROUND

This invention is directed to electrolytes for stable operation of electrochemical devices, certain embodiments of the electrolytes including an active salt, and a solvent in which the active salt is soluble.

### SUMMARY

One embodiment disclosed herein is an electrolyte composition comprising:

an active salt; and

a solvent portion that comprises at least 10 vol. % of at least one orthoformate or a mixture of orthoformates, based on the total volume of the solvent portion.

Another embodiment disclosed herein is a battery comprising:

(a) an electrolyte composition comprising:
an active salt; and
a solvent portion that comprises at 10 vol. % of at least one orthoformate or a mixture of orthoformates, based on the total volume of the solvent portion;

(b) an anode comprising a metal; and

(c) a cathode comprising a sulfur-containing material.

The foregoing and other objects, features, and advantages will become more apparent from the following detailed description, which proceeds with reference to the accompanying figures.

### BRIEF DESCRIPTION OF THE DRAWINGS

FIG. 1. Coulombic efficiency of Li metal in different electrolytes.

FIG. 2. Polysulfide solubility in different electrolytes at 55° C. for 16 hours.

FIG. 3. Top views of SEM images of Li metal deposition in the different electrolytes, (a) E1, (b) E3, (c) E4, and (d) E5. SEM images of Li deposits were obtained by plating 1 mAh cm⁻² Li on Cu substrate at a current density of 0.5 mA cm⁻².

FIG. 4. Cycling performance of Li∥S cells using different electrolytes in terms of (a) capacity and capacity retention and (b) CE. Li∥S cells were prepared with 3.5 mAh cm² S, 450 μm Li, 75 μl electrolyte and were charged/discharged at C/10 rate where 1C=3.5 mA cm⁻².

FIG. 5. Voltage profiles of Li∥S cells cycling in the different electrolytes, (a) E3 and (b) E5. Li∥S cells were prepared with 3.5 mAh cm⁻² S, 450 μm Li, 75 μl electrolyte and was charged/discharged at C/10 rate where 1C=3.5 mA cm⁻².

FIG. 6. Cross-section views of SEM images of the pristine S electrode (a) and the cycled S electrodes in the different electrolytes of (b) E3 and (c) E5 after 300 cycles.

FIG. 7. Voltage decay comparison of the fully charged Li—S batteries with different electrolytes. The Li∥S cells were prepared with 3.5 mAh cm⁻² S, 450 μm Li, and 75 electrolyte and was charged to 2.8 V at a current density of C/10 after 2 formation cycles at C/10 where 1C=3.5 mA cm⁻². The cells were rested for 48 h after fully charge.

FIG. 8. Comparison of charge/discharge capacities of Li—S batteries with different electrolytes after self-discharge test for 48 h at room temperature. The Li∥S cells were prepared with 3.5 mAh cm⁻² S, 450 μm Li, 75 μl electrolyte and was charged to 2.8 V at a current density of C/10 after 2 formation cycles at C/10 where 1C=3.5 mA cm⁻². The cells were rested for 48 h after fully charge.

FIG. 9. First cycle voltage profiles of Li∥S cells using different electrolytes under practical conditions with N/P ratio of 4 and E/C ratio of 4 μL mg S. Li∥S cells were prepared with 3.5 mAh cm⁻² S, 50 μm Li, ca. 18 μl electrolyte and were charged/discharged at C/10 where 1C=3.5 mA cm⁻².

FIG. 10. Cycling performance of Li∥S cells using different electrolytes under practical condition with N/P ratio of 4 and E/C ratio of 4 μL mg S. Li∥S cells were prepared with 3.5 mAh cm² S, 50 μm Li, ca. 18 μl electrolyte and were charged/discharged at C/10 where 1C=3.5 mA cm⁻².

FIG. 11. First cycle voltage profiles of Li∥S cells in the different electrolytes, (a) E3 and (b) E5. Li∥S cells were prepared with 3.5 mAh cm⁻² S, 250 μm Li, 75 μl electrolyte and were charged/discharged at C/10 rate where 1C=3.5 mA cm⁻².

FIG. 12. Cycling performance of Li∥S cells using different electrolytes in terms of capacity. Li∥S cells were prepared with 3.5 mAh cm⁻² S, 250 μm Li, 75 μl electrolyte and were charged/discharged at C/10 rate where 1C=3.5 mA cm⁻².

FIG. 13A is a schematic diagram of one exemplary embodiment of a rechargeable battery.

FIG. 13B is a schematic diagram of one embodiment of an anode-free rechargeable battery

### DETAILED DESCRIPTION

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 1997 (ISBN 0-471-29205-2).

To facilitate review of the various embodiments of the disclosure, the following explanations of specific terms are provided:

Active salt: As used herein, the term “active salt” refers to a salt that significantly participates in electrochemical processes of electrochemical devices. In the case of batteries, it refers to charge and discharge processes contributing to the energy conversions that ultimately enable the battery to deliver/store energy. As used herein, the term “active salt” refers to a salt that constitutes at least 5% of the redox active materials participating in redox reactions during battery cycling after initial charging.

Anode: An electrode through which electric charge flows into a polarized electrical device. From an electrochemical point of view, negatively-charged anions move toward the anode and/or positively-charged cations move away from it to balance the electrons leaving via external circuitry. In a discharging battery or galvanic cell, the anode is the negative terminal where electrons flow out. If the anode is composed of a metal, electrons that it gives up to the external circuit are accompanied by metal cations moving away from the electrode and into the electrolyte. When the battery is recharged, the anode becomes the positive terminal where electrons flow in and metal cations are reduced. For the purposes of this disclosure, “anode-free” refers to an initial, or uncharged, cell configuration in which only an anode current collector is present with no electrochemically active material.

Associated: As used here, the term “associated” means coordinated to or solvated by. For example, a cation that is associated with a solvent molecule is coordinated to or solvated by the solvent molecule. Solvation is the attraction of solvent molecules with molecules or ions of a solute. The association may be due to electronic interactions (e.g., ion-dipole interactions and/or van der Waals forces) between the cation and the solvent molecule. Coordination refers to formation of one or more coordination bonds between a cation and electron lone-pairs of solvent atoms. Coordination bonds also may form between the cation and anion of the solute.

BTFEMO: bis(2,2,2-trifluoroethyl) methyl orthoformate

Capacity: The capacity of a battery is the amount of electrical charge a battery can deliver. The capacity is typically expressed in units of mAh, or Ah, and indicates the maximum constant current a battery can produce over a period of one hour. For example, a battery with a capacity of 100 mAh can deliver a current of 100 mA for one hour or a current of 5 mA for 20 hours. Areal capacity or specific areal capacity is the capacity per unit area of the electrode (or active material) surface, and is typically expressed in united of mAh cm⁻².

Cathode: An electrode through which electric charge flows out of a polarized electrical device. From an electrochemical point of view, positively charged cations invariably move toward the cathode and/or negatively charged anions move away from it to balance the electrons arriving from external circuitry. In a discharging battery or galvanic cell, the cathode is the positive terminal, toward the direction of conventional current. This outward charge is carried internally by positive ions moving from the electrolyte to the positive cathode, where they may be reduced. When the battery is recharged, the cathode becomes the negative terminal where electrons flow out and metal atoms (or cations) are oxidized.

CEI: cathode electrolyte interphase

Cell: As used herein, a cell refers to an electrochemical device used for generating a voltage or current from a chemical reaction, or the reverse in which a chemical reaction is induced by a current. Examples include voltaic cells, electrolytic cells, and fuel cells, among others. A battery includes one or more cells. The terms “cell” and “battery” are used interchangeably when referring to a battery containing only one cell.

Cosolvent: A solvent that, in conjunction with another solvent, dissolves a solute.

Coulombic efficiency (CE): The efficiency with which charges are transferred in a system facilitating an electrochemical reaction. CE may be defined as the amount of charge exiting the battery during the discharge cycle divided by the amount of charge entering the battery during the charging cycle. CE of Li∥S or Na∥S cells may be defined as the amount of charge flowing out of the battery during Li or Na stripping process divided by the amount of charge entering the battery during Li or Na plating process.

DEC: diethyl carbonate

DFEC: difluoroethylene carbonate

DMC: dimethyl carbonate

DME: 1,2-dimethoxyethane

DMEC: dimethylene ethylene carbonate (4,5-dimethylene-1,3-dioxolan-2-one)

DMS: dimethyl sulfone

DMSO: dimethyl sulfoxide

DOL: 1,3-dioxolane

EC: ethylene carbonate

Electrolyte: A substance containing free ions that behaves as an electrically conductive medium. Electrolytes generally comprise ions in a solution, but molten electrolytes and solid electrolytes also are known.

EMC: ethyl methyl carbonate

EMS: ethyl methyl sulfone

EOFB: ethoxynonafluorobutane

EVS: ethyl vinyl sulfone

FEC: fluoroethylene carbonate

Flame retardant: As used herein, the term “flame retardant” refers to an agent incorporated into an electrolyte to reduce or eliminate its tendency to ignite during operation of an electrochemical device including the electrolyte.

Flammable: The term “flammable” refers to a material that will ignite easily and burn rapidly. As used herein, the term “non-flammable” means that an electrolyte, will not ignite or burn during operation of an electrochemical device including the electrolyte. As used herein, the terms “flame retarded” and “low flammability” are interchangeable and mean that a portion of the electrolyte may ignite under some conditions, but that any resulting ignition will not propagate throughout the electrolyte. Flammability can be measured by determining the self-extinguishing time (SET) of the electrolyte. The SET is determined by a modified Underwriters Laboratories test standard 94 HB. An electrolyte is immobilized on an inert ball wick, such as a ball wick having a diameter of ˜0.3-0.5 cm, which is capable of absorbing 0.05-0.10 g electrolyte. The wick is then ignited, and the time for the flame to extinguish is recorded. The time is normalized against the sample weight. If the electrolyte does not catch flame, the SET is zero and the electrolyte is non-flammable. Electrolytes having an SET of <6 s/g (e.g., the flame extinguishes within ˜0.5 s) are also considered non-flammable. If the SET is >20 s/g, the electrolyte is considered to be flammable. When the SET is between 6-20 s/g, the electrolyte is considered to be flame retarded or have low flammability.

FMES: trifluoromethyl ethyl sulfone

FMIS: trifluoromethyl isopropyl sulfone

FPMS: trifluoropropyl methyl sulfone

Hard carbon: A non-graphitizable carbon material. At elevated temperatures (e.g., >1500° C.) a hard carbon remains substantially amorphous, whereas a “soft” carbon will undergo crystallization and become graphitic.

Immiscible: This term describes two substances of the same state of matter that cannot be uniformly mixed or blended. Oil and water are a common example of two immiscible liquids.

Intercalation: A term referring to the insertion of a material (e.g., an ion or molecule) into the microstructure of another material. For example, lithium ions can insert, or intercalate, into graphite (C) to form lithiated graphite (LiC₆).

KFSI: potassium bis(fluorosulfonyl)imide

KTFSI: potassium bis(trifluoromethanesulfonyl)imide

LiBETI: lithium bis(pentafluoroethanesulfonyl)imide

LiFSI: lithium bis(fluorosulfonyl)imide

LiFTFSI: lithium (fluorosulfonyl trifluoromethanesulfonyl)imide

LiTFSI: lithium bis(trifluoromethanesulfonyl)imide

LiBOB: lithium bis(oxalato)borate

LiDFOB: lithium difluoro oxalato borate anion

MEC: methylene ethylene carbonate (4-methylene-1,3-dioxolan-2-one)

MFEC: methyl 2,2,2-trifluoroethyl carbonate

MOFB: methoxynonafluorobutane

NaFSI: sodium bis(fluorosulfonyl)imide

NaTFSI: sodium bis(trifluoromethylsulfonyl)imide

NaBETI: sodium bis(pentafluoroethanesulfonyl)imide

NaBOB: sodium bis(oxalato)borate

Nitrile: A compound that includes a —C≡N functional group.

Organophosphorus compound: An organic compound that contains phosphorus.

Orthoformate: An orthoformate compound is an orthoformic acid ester having a general formula

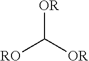

where each R independently is substituted alkyl, unsubstituted alkyl, aryl, or substituted aryl. In certain embodiments, the alkyl is a C₁-C₆ alkyl. The alkyl chain may be linear or branched. In certain embodiments, the aryl is phenyl or the substituted aryl is a substituted phenyl. In certain embodiments, one R group is an aryl or substituted aryl, and the remaining two R groups are alkyl or substituted alkyl. In certain embodiments, two R groups are an aryl or substituted aryl, and the remaining R group is alkyl or substituted alkyl. In certain embodiments, all three R groups are aryl or substituted aryl. In certain embodiments, all three R groups are alkyl or substituted alkyl. When the orthoformate is a fluorinated orthoformate, at least one R is a fluorinated alkyl or fluorinated aryl.

PC: propylene carbonate

Phosphate: As used herein, phosphate refers to an organophosphate having a general formula P(═O)(OR)₃ where each R independently is alkyl (e.g., C₁-C₁₀ alkyl) or aryl. Each alkyl or aryl group may be substituted or unsubstituted.

Phosphite: As used herein, phosphite refers to an organophosphite having a general formula P(OR)₃ or HP(O)(OR)₂ where each R independently is alkyl (e.g., C₁-C₁₀ alkyl) or aryl. Each alkyl or aryl group may be substituted or unsubstituted.

Phosphonate: A compound having a general formula P(═O)(OR)₂(R′) wherein each R and R′ independently is alkyl (e.g., C₁-C₁₀ alkyl), or aryl. Each alkyl or aryl group may be substituted or unsubstituted.

Phosphoramide: A compound having a general formula P(═O)(NR₂)₃ or P(═O)(NR₂)(OR′)₂ wherein each R independently is hydrogen, alkyl (e.g., C₁-C₁₀ alkyl), or alkoxy (e.g., C₁-C₁₀ alkoxy). At least one R is not hydrogen. Each alkyl or aryl group may be substituted or unsubstituted.

Phosphazene: A compound in which a phosphorus atom is covalently linked to a nitrogen atom or nitrogen-containing group by a double bond and to three other atoms or radicals by single bonds.

SEI: solid electrolyte interphase

Separator: A battery separator is a porous sheet or film placed between the anode and cathode. It prevents physical contact between the anode and cathode while facilitating ionic transport.

Soluble: Capable of becoming molecularly or ionically dispersed in a solvent to form a homogeneous solution. As used herein, the term “soluble” means that an active salt has a solubility in a given solvent of at least 1 mol/L (M, molarity) or at least 1 mol/kg (m, molality).

Solution: A homogeneous mixture composed of two or more substances. A solute (minor component) is dissolved in a solvent (major component). A plurality of solutes and/or a plurality of solvents may be present in the solution.

TDFEO: tris(2,2-difluoroethyl)orthoformate

TEPa: triethyl phosphate

TEPi: triethyl phosphite

TFEC: trifluoroethylene carbonate

TFEO: tris(2,2,2-trifluoroethyl)orthoformate

TFTE: 1,1,2,2,-tetrafluoroethyl-2,2,2-trifluoroethyl ether

THFiPO: tris(hexafluoroisopropyl)orthoformate

TMPa: trimethyl phosphate

TMPi: trimethyl phosphite

TMS: tetramethylene sulfone or sulfolane

TPFPO: tris(2,2,3,3,3-pentafluoropropyl)orthoformate

TTE: 1,1,2,2-tetrafluoroethyl-2,2,2,3-tetrafluoropropyl ether

TTPO: tris(2,2,3,3-tetrafluoropropyl)orthoformate

VC: vinylene carbonate

VEC: 4-vinyl-1,3-dioxolan-2-one or vinyl ethylene carbonate

### II. Electrolyte Compositions

Conventional carbonate electrolytes, e.g. LiPF₆ in EC/EMC or EC/DMC electrolytes, have good compatibility with the state of the art 4 V cathode and graphite anode-based lithium ion batteries. However, these electrolytes have poor stability with a lithium metal anode and a sulfur cathode. Ether based electrolytes (such as LiCF₃SO₃ in DME/DEGDME, LiTFSI in DOL/DEGDME) exhibit better compatibility with lithium. However, polysulfides are highly soluble in these electrolytes and lead to a polysulfides shuttle effect and low CE. The shuttle effect involves undesired transport of sulfur ions from the cathode to the anode. In general, the performance limitations of Li—S batteries originate from the insulating nature of sulfur, the shuttling effect of dissolved lithium polysulfide (LiPS) species, and their parasitic reactions with the highly reactive negative electrode. Dissolved LiPS diffuses into the separator as electrostatic attraction proceeds between charged polysulfide species and metallic lithium. Further loss of electroactive species continues while cycling, owing to chemical potential difference, and a concentration gradient can lead to mass transport in the electrolyte. Electrolytes including an appreciable concentration of polysulfides of Li₂S₆ shift the equilibria that involve the higher polysulfides and thereby alter the other species of the polysulfides in the solution, but these electrolytes usually exhibit high viscosity and low conductivity.

High concentration electrolytes, e.g. concentrated LiFSI/DME, concentrated LiFSI/DMC, or concentrated LiFSI/TEPa can enable high CE of Li metal anode, due to the formation of stabilized SEI layer and reduced presence of free solvent molecules in these electrolytes. However, these highly concentrated electrolytes suffer from their high cost, high viscosity, and poor wetting toward separator and the thick cathode electrode, hindering their practical use.

Disclosed herein are new electrolyte solvents (orthoformates) for rechargeable metal-S batteries. These solvents have limited solubility of polysulfides and are stable with alkali metals. They are also stable with conventional carbonaceous anodes and cathodes. In addition, these new solvents have a high boiling point (above 100° C.) and low melting point (−56.5° C.), which enable them to be applicable to a wide range of temperatures.

The electrolyte compositions includes at least one orthoformate as a solvent to form high efficiency, non-aqueous electrolyte compositions for metal-sulfur batteries. These novel electrolytes exhibit moderate Li salt concentration, low viscosity, excellent wetting ability with separator and electrodes, and great compatibility with alkali metal anodes and sulfur cathodes. They are also highly stable with an alkali metal anode, including a lithium metal anode. In addition, orthoformates have high boiling points and low melting points. Moreover, these orthoformate solvents have limited solubility of polysulfides, therefore largely limiting the shuttle effect which is one of the most significant barriers for Li—S batteries. In certain embodiments, these novel orthoformate based electrolytes can be prepared by dissolving an active lithium salt in a solvent composition that includes at least one orthoformate component, such as triethyl orthoformate, trimethyl orthoformate, or solvent mixtures that include at least one orthoformate.

Because of the low solubility of polysulfides in orthoformates, the formulated electrolytes also show limited solubility of polysulfides, which then significantly decrease the shuttle of polysulfides and increase the CE of the cells. The orthoformate component of the solvent suppresses deleterious polysulfide dissolution. Polysulfides include Li₂S₄, Li₂S₆ and Li₂S₈, and among them, Li₂S₈ has the highest solubility. The polysulfide solubility is determined by the solubility of Li₂S₈, which is prepared by adding a mixture of Li₂S and S at a mole ratio of (1:7) into the electrolyte. Li₂S₈ is dark brown when dissolved in the electrolyte, the lighter the color of the electrolyte, the lower content of the dissolved Li₂S₈ in the electrolyte. Orthoformate electrolytes show much lighter color than the most commonly used DME/DOL electrolyte for Li—S batteries

In addition, unlike the methods using high concentration electrolytes or addition of the polysulfide in the electrolyte solutions, the orthoformate electrolytes can largely reduce the viscosity of the electrolyte, which enables prompt wetting of the separator and the high loading cathodes, thereby improving the electrochemical performances of metal-S batteries.

By carefully selecting the orthoformates and optimizing electrolyte formulations by adjusting the ratios of salt, orthoformates and co-solvents, practical rechargeable metal-S batteries with significantly improved safety and charge/discharge performance can be achieved within a wide temperature range.

The orthoformate-containing electrolytes disclosed herein could be widely applied to other non-aqueous battery systems, including Li metal batteries, Li-ion batteries with Si, Si/C, SiOₓ, alloy, and/or metal oxide as anode, sodium metal and sodium ion batteries, Li—O₂ batteries, magnesium metal batteries, magnesium ion batteries, etc.

The orthoformate(s) is the electrolyte solvent for metal-sulfur batteries (such as lithium-sulfur (Li—S), sodium-sulfur (Na—S), magnesium-sulfur (Mg—S) and other metal-sulfur batteries). These orthoformate electrolytes are stable with current collectors (such as Cu and Al). They are not only stable with a metal anode by forming a high-quality solid electrolyte interphase (SEI) layer, but are also stable with sulfur cathodes, thereby improving long-term cycling stability of electrochemical cells. Furthermore, the orthoformate solvents effectively decrease the polysulfide solubility in the electrolyte and suppress the polysulfide shuttle in the metal-sulfur batteries. As a result, these electrolytes significantly improve the Coulombic efficiency (CE) and decrease the self-discharge of metal-sulfur batteries during storage. These electrolyte compositions could be widely applied to a variety of electrochemical systems, including Li—S, Na—S, Mg—S and Al—S batteries. They are also applicable to Li metal batteries paired with cathodes beyond S, Li-ion batteries with non-graphite anodes, Li—O₂ batteries, sodium metal and sodium ion batteries, magnesium ion batteries, supercapacitors, and sensors.

Triethyl orthoformate (TEO) had been used as a film-forming solvent in electrolytes for Li ion batteries with graphite anodes (Electrochimica Acta, 2006, 51(23), 4950). However, this electrolyte system (LiPF₆ in PC-TEO) was not stable with Li metal anode and sulfur cathode, which could not ensure long-term cycling of Li—S batteries. Low CE of Li metal anode in the electrolyte of LiPF₆ in PC-TEO makes this electrolyte impractical for Li metal batteries. U.S. Pat. No. 8,865,350B2 discloses the use of orthoformate in a nonaqueous electrolyte battery. However, they are used as additives in cyclic carbonate-based electrolytes, and the orthoformate content is limited to a value between 0.01 wt % and 1 wt %. In contrast, in certain embodiments of the current disclosure the orthoformate(s) is a significant portion of the solvent composition, for example, the solvent composition includes at least 10 vol. % of at least one orthoformate. These electrolytes are not only stable with Li metal anode, but also stable with sulfur cathodes, therefore largely improve the performance of Li—S batteries. The resulting electrolytes also have moderate Li salt concentration, reduced viscosity, increased conductivity, and stable operation of Li—S with higher CEs at a broad temperature window.

The current invention enables stable operation of high areal capacity loading Li—S batteries with high CE and low polysulfide solubility. The electrolytes with orthoformate(s) not only possess the unique functionalities of low polysulfide shuttle effect like the highly concentration electrolytes, but also exhibit the advantage of low cost associated with low concentration electrolytes (similar to the conventional electrolytes). The non-fluorinated orthoformate(s) are environment friendly and more cost-effective, which therefore can enable their large-scale industrial applications. The fluorinated orthoformates are also non-flammable.

The competitive advantages of including at least one orthoformate in the solvent composition include, but not limited to:
Stable with both Li metal anode and sulfur cathode and exhibiting a high CE of Li cycling during a wide temperature range.
Low polysulfide shuttle and less self-discharge during storage.
Low viscosity and high conductivity compared with highly concentrated electrolytes.
Low cost compared with highly concentrated electrolytes.
Able to achieve high ionic conductivity and non-flammability of the electrolytes by adjusting the different components (organic phosphorous solvents or additives) of the electrolytes.

The stability of electrolyte towards a Li metal anode is determined using Li∥Cu cell with the specific electrolyte. The higher the Li CE in Li∥Cu cells in a given electrolyte, the better the electrolyte stability toward Li metal anode. The Li CEs in orthoformate electrolytes as disclosed herein are above 99.3% at 30° C.

The stability of a sulfur cathode is mainly determined by the polysulfide solubility in a given electrolyte, with the lower polysulfide solubility during cycling, the sulfur cathode is more stable. When Li₂S₈ is added into solvents, orthoformate solvent exhibits much lighter color change than the conventional DME/DOL electrolyte used or Li—S batteries. This is clear evidence that orthoformate solvent disclosed herein can minimize the dissolving of polysulfide in a Li—S battery; therefore, improving the stability of the electrolyte and Li—S battery.

The solvent portion of the electrolyte composition includes at least 10 vol. % of at least one orthoformate or a mixture of orthoformates. “Solvent portion” refers to the solvent mixture of the electrolyte. If there is less than 10 vol. % of at least one orthoformate or a mixture of orthoformates, the solubility of polysulfides in the electrolyte composition is too high leading to severe shuttle effects and low CE. In certain embodiments, the solvent portion includes at least 10 vol. %, or at least 25 vol. %, or at least 50 vol %, of at least one orthoformate or a mixture of orthoformates.

In certain embodiments, the solvent portion may include up to 100 vol %, or up to 75 vol. %, or up to 50 vol %, or up to 25 vol. %, of at least one orthoformate or a mixture of orthoformates

In certain embodiments, the orthoformate may be non-fluorinated orthoformate. It has been found that a non-fluorinated orthoformate can dissolve an active salt used in a sulfur battery (for example, LiTFSI salt) and coordinate the salt cation. Illustrative non-fluorinated orthoformates include:

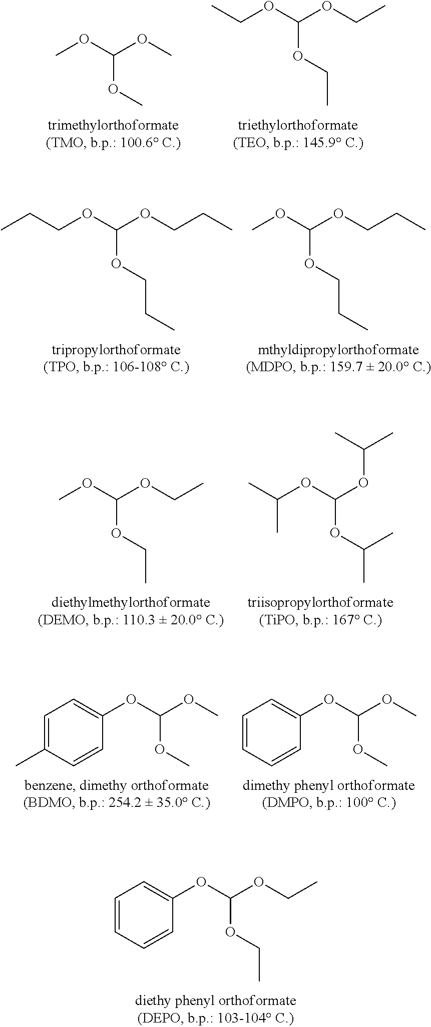

Molecular structures and boiling points of orthoformates, boiling point values with ±35.0° C. or ±20.0° C. were predicted by ChemDraw.

In certain embodiments, the orthoformate is a fluorinated orthoformate. Illustrative fluorinated orthoformates include:

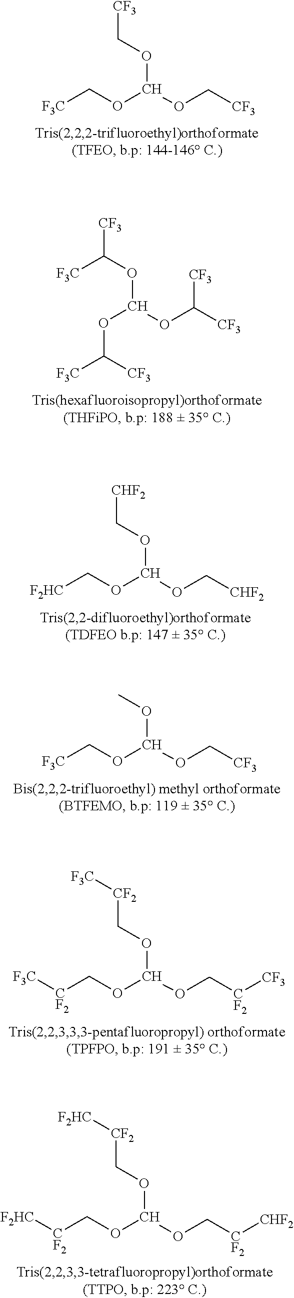 [SMILES: FC(F)(F)COC(OCC(F)(F)F)OCC(F)(F)F ; FC(F)(F)C(OC(OC(C(F)(F)F)C(F)(F)F)OC(C(F)(F)F)C(F)(F)F)C(F)(F)F ; FC(F)COC(OCC(F)F)OCC(F)F ; COC(OCC(F)(F)F)OCC(F)(F)F ; FC(F)(F)C(F)(F)COC(OCC(F)(F)C(F)(F)F)OCC(F)(F)C(F)(F)F ; FC(F)C(F)(F)COC(OCC(F)(F)C(F)F)OCC(F)(F)C(F)F]

Molecular structures and boiling points of fluorinated orthoformates, boiling point values with ±35.0° C. or ±20.0° C. is predicted by Chemdraw.

In addition to the at least one orthoformate, the electrolyte composition may include at least one co-solvent. The co-solvent may be present in the solvent portion in an amount of 10 to 90, more particularly 25 to 75, and most particularly 40 to 60 vol. %. Suitable solvents for use as the co-solvent include, but are not limited to, certain carbonate solvents, ether solvents, sulfone solvents, phosphate solvents, ester solvents (e.g., aliphatic ester solvents), lactones, sulfoxides, water, nitriles, flame retardant compounds, and mixtures thereof. Illustrative co-solvents include an ether: such as 1,2-dimethoxyethane (DME), diethylene glycol dimethyl ether (DEGDME, or diglyme), triethylene glycol dimethyl ether (triglyme), tetraethylene glycol dimethyl ether (tetraglyme), 1,3-dioxolane (DOL), allyl ether; a carbonate: such as dimethyl carbonate (DMC), ethyl methyl carbonate (EMC), diethyl carbonate (DEC), ethylene carbonate (EC), propylene carbonate (PC), vinylene carbonate (VC), fluoroethylene carbonate (FEC), 4-vinyl-1,3-dioxolan-2-one (VEC), 4-methylene-1,3-dioxolan-2-one (also called methylene ethylene carbonate (MEC)), 4,5-dimethylene-1,3-dioxolan-2-one (DMEC); a sulfone: such as dimethyl sulfone (DMS), ethyl methyl sulfone (EMS), ethyl vinyl sulfone (EVS), tetramethylene sulfone (TMS, also called sulfolane); sulfoxides: such as dimethyl sulfoxide (DMSO); an ester: such as methyl butyrate, ethyl butyrate, ethyl propionate, ethyl acetate, methyl acetate (MA), butyl formate, gamma-butyrolactone, γ-valerolactone, δ-valerolactone; a phosphate: such as trimethyl phosphate (TMP), triethyl phosphate (TEP), tributyl phosphate (TBP), triphenyl phosphate (TPP), tris(2,2,2-trifluoroethyl) phosphate (TFEP), bis(2,2,2-trifluoroethyl) methyl phosphate; a phosphite: such as trimethyl phosphite, triphenyl phosphite, tris(2,2,2-trifluoroethyl) phosphite; a phosphonate: such as dimethyl methylphosphonate, diethyl ethylphosphonate, diethyl phenylphosphonate, bis(2,2,2-trifluoroethyl) methylphosphonate; a phosphazene: such as hexamethoxyphosphazene, hexafluorophosphazene; other phosphorus chemicals: such as hexamethylphosphoramide; a nitrile: such as acetonitrile, propionitrile, succinonitrile, adiponitrile; an amine—such as triethyl amine, triallyl amine; a cyanurate: such as triallyl cyanurate; an isocyanurate: such as triallyl isocyanurate; water, or any combination thereof.

The orthoformate and the co-solvent have good miscibility with each other so that they can be mixed together.

In certain embodiments, the electrolyte composition includes at least 10 vol. %, at least 25 vol. %, or at least 50 vol. % DME. The DME facilitates salt solubility, particularly LiNO₃ solubility.

In certain embodiments, the solvent portion may also include a flame-retardant compound. The amount of flame-retardant compound in the solvent portion is sufficient to render the electrolyte flame-retarded (low flammability) or non-flammable. Such amounts can be determined by those of ordinary skill in the art having had the benefit of reading this disclosure, and depends on the solvent chosen as well as the amount. In any or all embodiments, the solvent portion may include at least 5 wt % of the flame-retardant compound. In some embodiments, the solvent portion comprises at least 5 wt % or at least 10 wt % of the flame-retardant compound. In certain embodiments, the solvent portion comprises 5-75 wt % of the flame-retardant compound, such as 5-60 wt %, 5-50 wt %, 5-40 wt % or 5-30 wt %, 10-60 wt %, 10-50 wt %, 10-40 wt %, or 10-30 wt % of the flame-retardant compound. In some embodiments, the flame-retardant compound is a liquid at ambient temperature (e.g., 20-25° C.). Suitable flame-retardant compounds include, but are not limited to, phosphorus containing compounds. In some embodiments, the flame-retardant compound comprises one or more organophosphorus compounds (e.g., organic phosphates, phosphites, phosphonates, phosphoramides), phosphazenes, or any combination thereof. Organic phosphates, phosphites, phosphonates, phosphoramides include substituted and unsubstituted aliphatic and aryl phosphates, phosphites, phosphonates, and phosphoramides. The phosphazenes may be organic or inorganic. Exemplary flame retardant compounds include, e.g., trimethyl phosphate (TMPa), triethyl phosphate (TEPa), tributyl phosphate, triphenyl phosphate, tris(2,2,2-trifluoroethyl) phosphate, bis(2,2,2-trifluoroethyl) methyl phosphate, trimethyl phosphite, triphenyl phosphite, tris(2,2,2-trifluoroethyl) phosphite, dimethyl methylphosphonate, diethyl ethylphosphonate, diethyl phenylphosphonate, bis(2,2,2-trifluoroethyl) methylphosphonate, hexamethylphosphoramide, hexamethoxyphosphazene (cyclo-tris(dimethoxyphosphonitrile), hexamethoxycyclotriphosphazene), hexafluorophosphazene (hexafluorocyclotriphosphazene), and combinations thereof.

The active salt is a salt, or combination of salts, that participates in the charge and discharge processes of a cell including the electrolyte. The active salt comprises a cation that is capable of forming redox pairs having different oxidation and reduction states, such as ionic species with differing oxidation states or a metal cation and its corresponding neutral metal atom. In some embodiments, the active salt is an alkali metal salt, an alkaline earth metal salt, or any combination thereof. The active salt may be, for example, a lithium salt, a sodium salt, a potassium salt, a magnesium salt, a mixture of lithium salts, a mixture of sodium salts, a mixture of potassium salts, or a mixture of magnesium salts. Advantageously, the active salt is stable towards an alkali metal, alkaline earth metal, carbon-based, silicon-based, carbon/silicon-based, tin-based, or antimony-based anode. Exemplary salts include, but are not limited to, LiFSI, LiTFSI, LiFTFSI, LiBETI, NaFSI, NaTFSI, NaBETI, LiBOB, sodium bis(oxalato)borate (NaBOB), LiPF₆, LiAsF₆, LiBF₄, LiCF₃SO₃, LiClO₄, LiDFOB, LiI, LiBr, LiCl, LiSCN, LiNO₃, LiNO₂, Li₂SO₄, and combinations thereof.

In some embodiments, the active salt is LiTFSI.

In certain embodiments, the electrolyte composition may also include one or more of a lithium sulfide or a lithium polysulfide of the general formula Li₂Sₙ, 1≤n≤8.

The electrolyte composition disclosed herein may have an active salt concentration, particularly a Li salt, concentration of between 0.5 M and 2.5 M salt concentration, preferably between 1 M to 2 M.

In certain embodiments, the electrolyte composition includes a compatibility agent, such as LiNO₃, that functions as an effective film-forming additive and can form a good solid electrolyte interphase (SEI) film on Li metal anodes, thus protecting the Li metal anode and improving the cycling performance LiNO₃ is particularly useful in Li—S batteries. Other components, such as RNO₃ (R is cesium (Cs), rubidium (Rb), lanthanum (La), potassium (K)), pyrrole, triphenylphosphine, LiX (X═Br, I) and InI₃ can also incorporated as additives in these orthoformate based electrolytes.

The electrolyte composition may have a viscosity of 1 to 10 cp at 30° C., more preferably 1 to 5 cp at 30° C.

Wettability of the separator and the electrodes can be determined by testing the contact angel of the electrolyte drop on the separator and electrode surface.

### III. Batteries

Embodiments of the disclosed electrolyte composition are useful in batteries (e.g., rechargeable batteries), sensors, and supercapacitors. Suitable batteries include, but are not limited to, metal-sulfur batteries, including lithium-sulfur batteries and sodium-sulfur batteries.

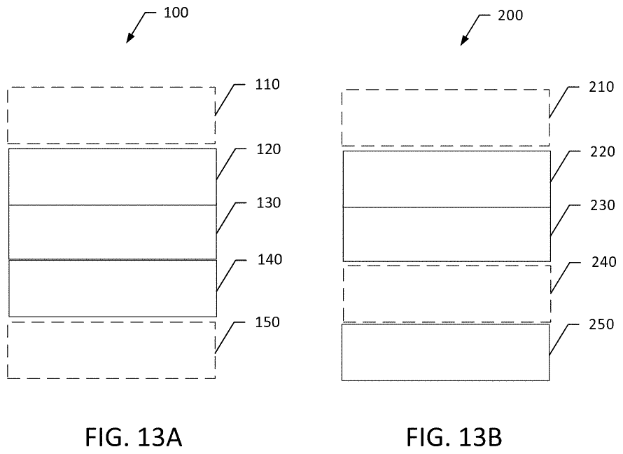

In some embodiments, a rechargeable battery comprises an electrolyte as disclosed herein, a cathode, an anode, and optionally a separator. FIG. 13A is a schematic diagram of one exemplary embodiment of a rechargeable battery 100 including a cathode 120, a separator 130 which is infused with an electrolyte, and an anode 140. In some embodiments, the battery 100 also includes a cathode current collector 110 and/or an anode current collector 150.

FIG. 13B is a schematic diagram of one embodiment of an anode-free rechargeable battery 200. The battery 200 includes a cathode 220, a separator 230 which, in some embodiments, is infused with an electrolyte, and an anode current collector 250. In some embodiments, the battery 200 also includes a cathode current collector 210. During a charging process of the battery 200, an anode 240 is formed in situ on the surface of the anode current collector 250 facing the separator 230. By “in situ” is meant that the anode forms during a charging process of the battery. The anode active material 240 is at least partially consumed during a discharging process of the battery 200. In some embodiments, the anode active material 240 is completely consumed during a discharging process of the battery 200. In some embodiments, the anode-active material is an alkali metal or alkaline earth metal. Exemplary anode-active materials include lithium, sodium, potassium, and magnesium. In certain embodiments, the anode-active material is lithium or sodium.

The current collectors can be a metal or another conductive material such as, but not limited to, nickel (Ni), copper (Cu), aluminum (Al), iron (Fe), stainless steel, or conductive carbon materials. The current collector may be a foil, a foam, or a polymer substrate coated with a conductive material. Advantageously, the current collector is stable (i.e., does not corrode or react) when in contact with the anode or cathode and the electrolyte in an operating voltage window of the battery. The anode and cathode current collectors may be omitted if the anode or cathode, respectively, are free standing, e.g., when the anode is metal or a free-standing film comprising an intercalation material or conversion compound, and/or when the cathode is a free-standing film. By “free-standing” is meant that the film itself has sufficient structural integrity that the film can be positioned in the battery without a support material.

In some embodiments, the anode is a metal (e.g., lithium, sodium), an intercalation material, or a conversion compound. The intercalation material or conversion compound may be deposited onto a substrate (e.g., a current collector) or provided as a free-standing film, typically, including one or more binders and/or conductive additives. Suitable binders include, but are not limited to, polyvinyl alcohol, polyvinyl chloride, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, epoxy resin, nylon, and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives). Exemplary anodes for lithium batteries include Li metal, carbon anode, Si or Si/C anode. Exemplary anodes for sodium batteries include, but are not limited to Na metal, phosphorous, antimony, tin, germanium, alloy components, oxides. For the Li—S and Na—S batteries, Li metal is used as anode.

In certain embodiments, the cathode includes a sulfur-containing material. The sulfur-containing material may include sulfur, a sulfur compound, a sulfur-based composite material, or any combination thereof. Sulfur may include elemental sulfur, typically in the form of particles, such as microparticles or nanoparticles. Elemental sulfur includes crystalline sulfur, amorphous sulfur, precipitated sulfur, and melt-solidified sulfur.

Sulfur compounds may include lithium sulfides or polysulfides of the types typically formed during operation of a Li—S battery, such as Li₂S₂, Li₂S, or Li₂Sₙ, 4≤n≤0.8. Sulfur compounds may also include sulfur oxides and organic materials containing sulfur. These sulfur compounds may be provided in the form of particles, or as a liquid or gel catholyte. Catholyte portions of the sulfur-based core may also be formed during operation of the Li—S battery.

The sulfur-containing material may also contain more structured sulfur composites, such as sulfur-carbon composites, including those that contain sulfur at a micro or nano-scale within carbon pores. The sulfur-containing material may include a sulfur-carbon composite, a sulfur-polymer composite, a sulfur-sulfur compound composite, or any combinations thereof.

Any combinations of any of the foregoing types of elemental sulfur, sulfur compounds, or sulfur composites may be used in the cathode.

The cathode can comprise a carbon material (e.g., carbon black, nanoparticulate carbon, microparticulate carbon, carbon nanotubes, graphene, and the like) in addition to the sulfur. The binder also can comprise a conventional binder material such as polyvinylidene difluoride (also known as poly(vinylidene difluoride) of polyvinylidene fluoride; PVdF), a polyurethane, a polyethylene oxide (PEO), a styrene-butadiene rubber (SBR), a carboxymethylcellulose (CMC), a polyvinylpyrrolidone (PVP)

The separator may be glass fiber, a porous polymer film (e.g., polyethylene- or polypropylene-based material) with or without a ceramic coating, or a composite (e.g., a porous film of inorganic particles and a binder). One exemplary polymeric separator is a Celgard® K1640 polyethylene (PE) membrane. Another exemplary polymeric separator is a Celgard® 2500 polypropylene membrane. Another exemplary polymeric separator is a Celgard® 3501 surfactant-coated polypropylene membrane. Another separator is solid LISICON ceramic membranes. LISICON is an acronym for LIthium Super Ionic CONductor, which refers to a family of solid solution materials with the chemical formula Li₂₊₂ₙ Zn₁₋ₙGeO₄ and similar compositions comprising other combinations of metal ions an metal oxides, which are characterized by high lithium ion conductivities due to movement of Li ions among interstitial sites of the LISICON crystal lattice, allowing for lithium ion conductivity without being porous materials. The separator may be infused with an electrolyte, as disclosed herein.

The orthoformate based electrolytes have ionic conductivity in the range of 2-15 mS cm at 25° C., which is sufficient for Li⁺ conducting in the Li—S batteries.

In certain embodiments, the electrolyte compositions provide stable operation of Li—S batteries with higher CEs at a broad temperature window (from −40° C. to 60° C.).

These features enable stable operation of high arel capacity loading Li—S batteries with high CE and low polysulfide solubility. The electrolytes with orthoformates not only possess the unique functionalities of low polysulfide shuttle effect like the highly concentration electrolytes, but also exhibit the advantage of low cost associated with low concentration electrolytes (similar to the conventional electrolytes).

Table 1 below shows the physical properties of the representatives of the linear ether 1,2-dimethoxyethane (DME), cyclic ether 1,3-dioxolane (DOL) and the branched orthoformate TEO. Compared to the commonly used DME and DOL, TEO has a much higher boiling point (b.p.), which benefits its potential application at elevated temperatures.

TABLE 1
Comparison of physical properties of the representative linear and cyclic ethers and branch
structured orthoformate

| | | | | b.p. | m.p. |
|---|---|---|---|---|---|
| Compounds | Structure | Molar mass | Density g/cm³ | ° C. | ° C. |
| Linear: DME | 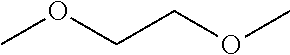 | 90.12 | 0.88 | 85 | −58 |
| Cyclic: DOL | 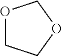 | 74.08 | 1.06 | 75 | −95 |
| Branched: TEO | 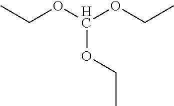 | 148.2 | 0.89 | 145.9 | −76 |

### III. Examples

### Example 1

Table 2 shows the formulations of the orthoformate-based electrolytes together with conventional electrolytes E1, E2 and E3 as reference electrolytes. In E4 and E5 the TEO was present at 50 vol. % (TEO/DOL were mixed together at a 1:1 volume ratio; DME/TEO were mixed together at a 1:1 volume ratio). As shown in Table 2, electrolytes with TEO, E4 and E5, have slightly higher viscosity and lower conductivity than the baseline E1, however, the electrolytes containing TEO have much higher CE than the conventional carbonate electrolyte (E1) and ether-based electrolyte E2, and it is similar with E3.

TABLE 2
Electrolyte, formulations and their basic properties used in Example 1

| | | Conductivity | | Coulombic |
|---|---|---|---|---|
| | | at 30° C. | Viscosity at | efficiency in |
| Electrolyte | Formulation | mS/cm | 30° C. cp | Li∥Cu |
| E1 | 1 M LiPF₆ in EC/EMC | 9.26 | 2.00 | 93.86% |
| | (3/7) + 2 wt.% VC | | | |
| E2 | 1 M LiTFSI in DME/DOL | 13.09 | 1.33 | 92.57% |
| E3 | 1 M LiTFSI in DME/DOL | 12.15 | 1.81 | 99.32% |
| | (1/1) + 0.3 M LiNO₃ | | | |
| E4 | 1 M LiTFSI in TEO/DOL | 2.70 | 2.14 | 99.26% |
| | (1/1) + 0.3 M LiNO₃ | | | |
| | (LiNO₃ not dissolved) | | | |
| E5 | 1 M LiTFSI in DME/TEO | 6.57 | 2.56 | 99.34% |
| | (1/1) + 0.3 M LiNO₃ | | | |

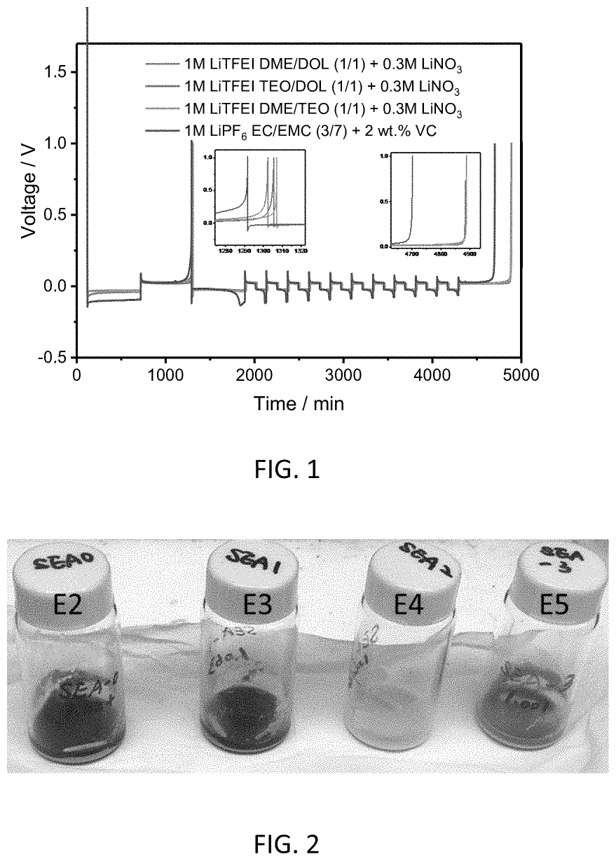

FIG. 1 shows the CE in different electrolytes. All the electrolytes (E3, E4 and E5) based on ethers and orthoformates show much high CE of above 99%, which is much higher than the conventional carbonate electrolyte E1 and the regular ether electrolyte E2.

FIG. 2 shows the solubility of polysulfide in different electrolytes at 55° C. for 16 hours (h). With the TEO in E4 and E5, the color of the electrolyte solutions is much lighter compared to the reference electrolytes E2 and E3, which is beneficial for suppressing the polysulfide shuttle effect and improving the cell CE.

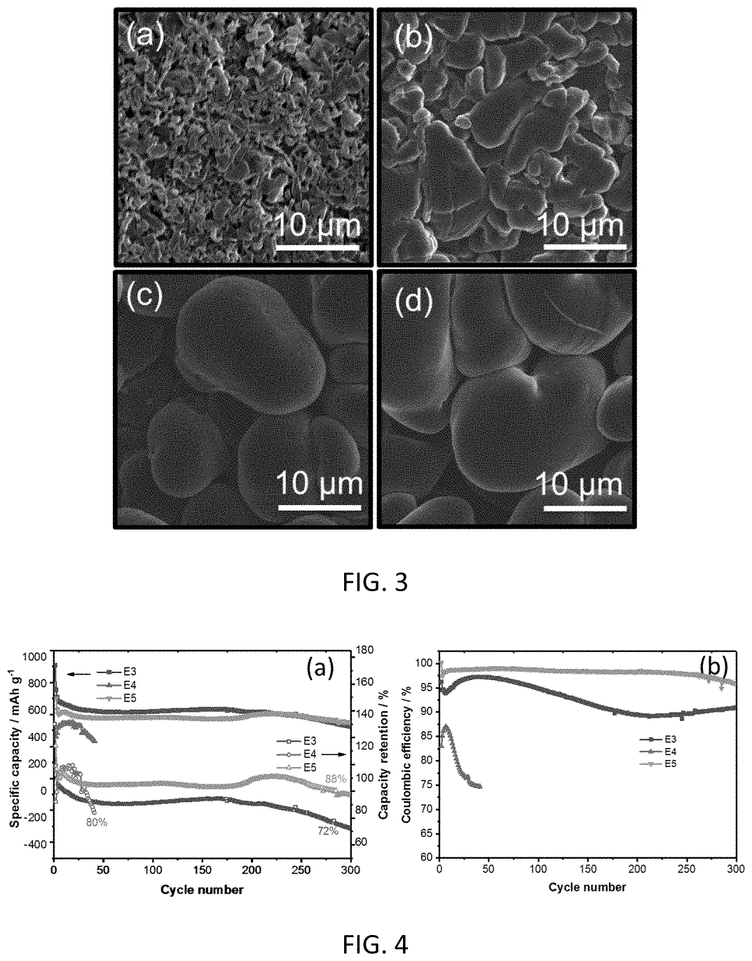

FIG. 3 shows the Li deposition morphology in different electrolytes. Compared to the reference electrolyte E1, where dendritic Li formed on the Cu substrate, Li deposited in the E3 of DME/DOL is less dendritic, but with mixtures of Li particles at different sizes. For the TEO using electrolytes E4 and E5, large granular Li particles formed, which effectively lowers the surface area of the deposited Li and is beneficial for decreasing the side reactions between electrolyte and Li metal.

FIG. 4 shows the cycling performance of Li∥S cells with different electrolytes. The S electrode was prepared with 80% integrated Ketjenblack/sulfur composite (IKB/S), 10% CMC binder and 10% CNF. E4, 1 M LiTFSI in TEO/DOL+0.3 M LiNO₃ electrolyte shows poor cycling performance and low CE because of the poor solubility of LiNO₃ that functions as an important additive for Li—S batteries. E3, 1 M LiTFSI DME/DOL+0.3 M LiNO₃ as one of the best electrolytes reported for Li—S batteries, shows a relatively stable cycling performance in the Li∥S cell as shown in FIG. 4(a). However, as shown in FIG. (b), the CE of the cell using this electrolyte (E3) is not good, where the initial CE of 95% slightly increased to 97% but then showed a fast CE decay after 40 cycles. By using the E5, 1 M LiTFSI in DME/TEO (1/1)+0.3 M LiNO₃, although the initial capacity of the Li∥S cell is slightly lower than E3, the capacity of the cell with E5 is higher than that of the E3 after 270 cycles as shown in the FIG. 4(a). More importantly, the capacity retention (FIG. 4(a)) and the CE value (FIG. 4(b)) of the cell with E5 is significantly improved compared to those using the conventional electrolyte E3.

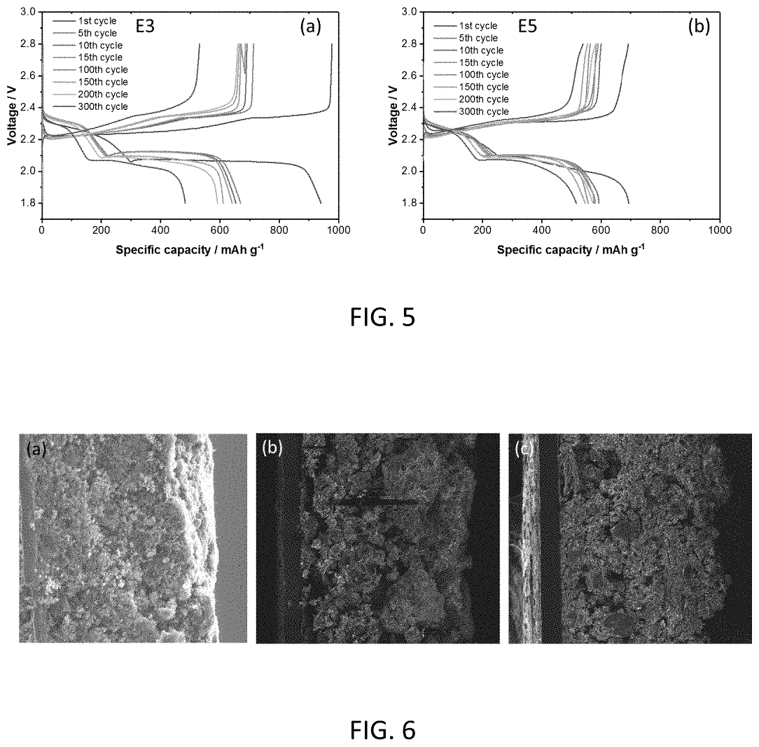

FIG. 5 shows the charge/discharge curves of the Li∥S cells with E3 and E5 with cycling. As shown in FIG. 5(a), E3 has the high capacity of ca. 950 mAh/g in the first cycle, but its capacity decreases very quickly to 650 mAh/g in the 5^{th} cycle and leads to a steady cycling till ca. 200 cycles before an accelerated capacity-fade occurs. The capacity retention is 72% after 300 cycles. For the cell using E5, although its initial capacity of 700 mAh/g (shown in the FIG. 5(b)) is lower than that of E3, it is much stable over the cycling with a capacity retention of 88% after 300 cycles.

FIG. 6 shows the cross-section views of SEM images of pristine S electrodes and those after 300 cycles in E3 and E5. Compared to the pristine S electrode shown in FIG. 6(a), large gaps were observed in the S electrode after long-term cycling in the E3 electrolyte shown in FIG. 6(b). In the contrast, the S electrode cycled in E5 electrolytes (FIG. 6(c)) well preserved their pristine structure after 300 cycles.

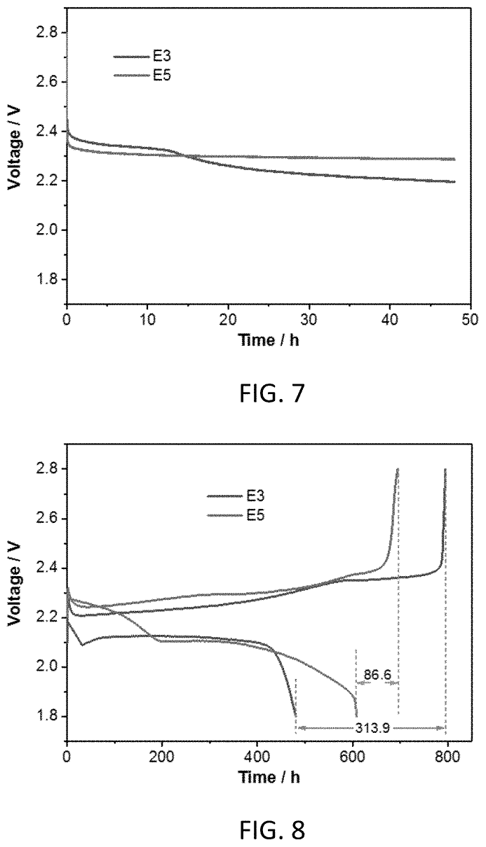

FIG. 7 shows the voltage decay of Li—S batteries at fully charged state. The Li—S cells with different electrolytes were firstly charged to 2.8 V, and then rest for 48 h before discharging them. As shown in FIG. 7, both cells have a voltage drop at the initial state due to the IR drop. The cell with E5 has a larger voltage drop than the one with E3, which is likely because that E5 has lower ionic conductivity. However, after the initial voltage drop, the voltage in the cell with TEO based electrolyte (E5) is almost a consistent during the 48-h resting time (2.3 V at the end) while the cell with the reference electrolyte (E3) shows a continuous voltage decay during the resting time (2.2 V at the end). It indicates that the cell with the TEO based electrolyte is much more stable at charged state.

The cells after self-discharge test (i.e. resting test for 48 h at charged state to check the voltage drop) were discharged and then conducted regular charge/discharge cycling to see how the storage affects the capacity. As shown in FIG. 8, compared to the charge/discharge cycle before resting test, the Li∥S cell with E3 electrolyte after resting test of 48 h shows 313.9 mAh g difference between the charge capacity and the discharge capacity, which means that 39.5% of the charged capacity (794.6 mAh g⁻¹) is lost during the 48-h resting time. As for the cell with E5, the capacity difference is only 86.6 mAh g⁻¹, which is 12.5% loss of its charged capacity (694 mAh g⁻¹) after storage. These results clearly proved that the TEO based electrolyte E5 has much better capacity retention capability at charged state.

### Example 2

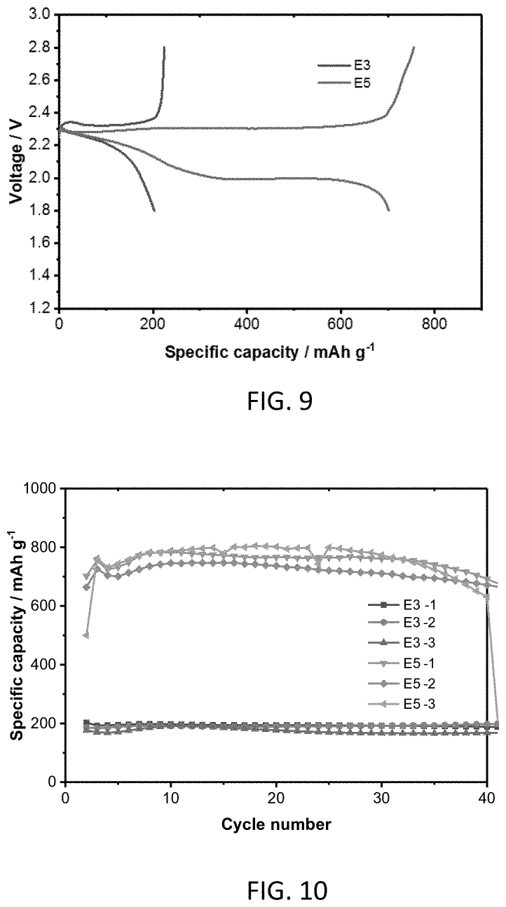

FIG. 9 shows the first cycle charge/discharge voltage profiles of the Li∥S cells at practical conditions with low capacity ratio of anode/cathode (i.e. N/P ratio) of 4 and lean electrolyte (with electrolyte/capacity (E/C) ratio of 4 μL mg⁻¹). In this practical condition, the cell with reference electrolyte E3 has a very low specific discharge capacity of ca. 200 mAh g which is possibly caused by the low utilization of S electrode with the very low electrolyte amount. As for the TEO-containing electrolyte E5, a much higher specific discharge capacity of ca. 720 mAh g is still obtained in the cell.

FIG. 10 shows the cycling performance of the Li∥S cells at practical conditions. Three parallel cells were tested for each electrolyte. The specific capacity of ca. 200 mAh g is observed in all three parallel cells with reference electrolyte E3. Much higher specific capacity of ca. 700-800 mAh g is obtained in the cells with the TEO based electrolyte E5. All the cells are stable over 40 cycles. These results clearly show that the TEO based electrolyte is much suitable for the practical use.

### Example 3

The amount of orthoformate solvent can be varied in the electrolyte compositions. Table 3 shows the electrolytes with different DME/TEO ratios in the electrolytes.

TABLE 3
Electrolyte formulations used in Example 6

| Electrolyte | Formulation |
|---|---|
| E5 | 1 M LiTFSI in DME/TEO |
| | (1/1 by vol) + 0.3 M LiNO₃ |
| E13 | 1 M LiTFSI in DME/TEO |
| | (1/3 by vol) + 0.3 M LiNO₃ |

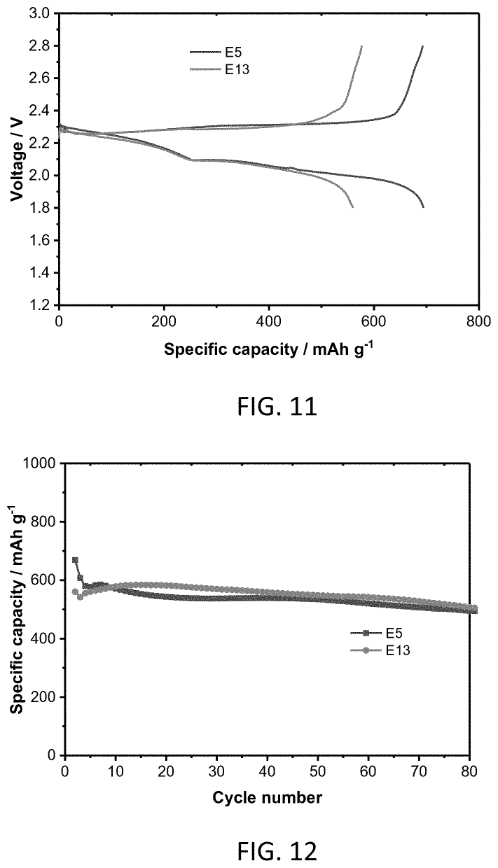

FIG. 11 shows the first cycle charge/discharge voltage profiles of Li—S cells with the electrolytes containing different volume ratios of DME and TEO in the solvent mixtures. The cell with higher amount of TEO in the electrolyte (E13) shows relatively lower initial specific capacity.

FIG. 12 shows the cycling performance of the Li∥S cells with E5 and E13. The cells containing both E5 and E13 with different DME/TEO volume ratios show similar cycling stability.

The electrolyte composition disclosed herein can be used in a variety of electrochemical systems, including Li metal batteries, Li-ion batteries using with Si, Si/C, SiOx, alloy, metal oxide or Si composite as the anode, Li—O2 batteries, sodium ion batteries, Mg—S batteries, super capacitors, sensors.

In view of the many possible embodiments to which the principles of the disclosed invention may be applied, it should be recognized that the illustrated embodiments are only preferred examples of the invention and should not be taken as limiting the scope of the invention.

What is claimed is:

1. An electrolyte composition comprising:
an active salt; and
a solvent portion that comprises at least 10 vol. % of at least one orthoformate or a mixture of orthoformates, based on the total volume of the solvent portion.

2. The electrolyte composition of claim 1, wherein the orthoformate is: 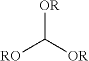
where each R independently is substituted alkyl, unsubstituted alkyl, aryl, or substituted aryl.

3. The electrolyte composition of claim 2, wherein each R is a C₁-C₆ alkyl.

4. The electrolyte composition of claim 2, wherein at least one R is phenyl or substituted phenyl.

5. The electrolyte composition of claim 1, wherein the orthoformate is trimethylorthoformate, triethylorthoformate, tripropylorthoformate, methyldipropylorthoformate, diethylmethylorthoformate, triisopropylorthoformate, benzene dimethyl orthoformate, dimethyl phenyl orthoformate, or diethyl phenyl orthoformate.

6. The electrolyte composition of claim 1, wherein the active salt is lithium bis(trifluoromethanesulfonyl)imide.

7. The electrolyte composition of claim 1, wherein the solvent portion further comprises at least one co-solvent.

8. The electrolyte composition of claim 7, wherein the co-solvent is selected from a carbonate, an ether, a sulfone, a phosphate, an ester, a lactone, a sulfoxide, a nitrile, or a flame-retardant compound.

9. The electrolyte composition of claim 7, wherein the co-solvent is 1,2-dimethoxyethane.

10. The electrolyte composition of claim 9, wherein the orthoformate is trimethylorthoformate, triethylorthoformate, tripropylorthoformate, methyldipropylorthoformate, diethylmethylorthoformate, triisopropylorthoformate, benzene dimethyl orthoformate, dimethyl phenyl orthoformate, or diethyl phenyl orthoformate; and the active salt is lithium bis(trifluoromethanesulfonyl)imide.

11. The electrolyte composition of claim 10, further comprising LiNO₃.

12. The electrolyte composition of claim 1, wherein the solvent portion comprises 10 vol. % to 75 vol. % of at least one orthoformate or a mixture of orthoformates.

13. The electrolyte composition of claim 1, wherein the solvent portion comprises at least 25 vol. % of at least one orthoformate or a mixture of orthoformates.

14. The electrolyte composition of claim 1, further comprising LiBr.

15. A battery comprising:
(a) an electrolyte composition comprising:
an active salt; and
a solvent portion that comprises at 10 vol. % of at least one orthoformate or a mixture of orthoformates, based on the total volume of the solvent portion;
(b) an anode comprising a metal; and
(c) a cathode comprising a sulfur-containing material.

16. The battery of claim 15, wherein the anode comprises lithium metal.

17. The battery of claim 15, wherein the battery is a Li—S battery.

18. The battery of claim 15, wherein the orthoformate is: 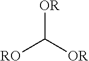
where each R independently is substituted alkyl, unsubstituted alkyl, aryl, or substituted aryl.

19. The battery of claim 18, wherein each R is a C₁-C₆ alkyl.

20. The battery of claim 18, wherein at least one R is phenyl or substituted phenyl.

21. The battery of claim 15, wherein the orthoformate is trimethylorthoformate, triethylorthoformate, tripropylorthoformate, methyldipropylorthoformate, diethylmethylorthoformate, triisopropylorthoformate, benzene dimethyl orthoformate, dimethyl phenyl orthoformate, or diethyl phenyl orthoformate.

22. The battery of claim 15, wherein the active salt is lithium bis(trifluoromethanesulfonyl)imide.

23. The battery of claim 15, wherein the solvent portion further comprises at least one co-solvent.

24. The battery of claim 23 wherein the co-solvent is selected from a carbonate, an ether, a sulfone, a phosphate, an ester, a lactone, a sulfoxide, a nitrile, or a flame-retardant compound.

25. The battery of claim 23, wherein the co-solvent is 1,2-dimethoxyethane.

26. The battery of claim 25, wherein the orthoformate is trimethylorthoformate, triethylorthoformate, tripropylorthoformate, methyldipropylorthoformate, diethylmethylorthoformate, triisopropylorthoformate, benzene dimethyl orthoformate, dimethyl phenyl orthoformate, or diethyl phenyl orthoformate; and the active salt is lithium bis(trifluoromethanesulfonyl)imide.

27. The battery of claim 26, wherein the solvent portion comprises 10 vol. % to 75 vol. % of at least one orthoformate or a mixture of orthoformates.

28. The battery of claim 26, wherein the solvent portion comprises at least 25 vol. % of at least one orthoformate or a mixture of orthoformates.
